(19) United States
(12) Patent Application Publication
(10) Pub. No.: US 2018/0068492 A1
(43) Pub. Date: Mar. 8, 2018

(54) IMAGE PROCESSING DEVICE, IMAGE PROCESSING METHOD, AND IMAGE PROCESSING PROGRAM

(71) Applicant: TOPCON CORPORATION, Tokyo (JP)

(72) Inventors: Naoki MORIKAWA, Tokyo (JP); Tadayuki ITO, Tokyo (JP)

(73) Assignee: TOPCON CORPORATION, Tokyo (JP)

(21) Appl. No.: 15/689,029

(22) Filed: Aug. 29, 2017

(30) Foreign Application Priority Data
Sep. 6, 2016 (JP) 2016-173468

(51) Int. Cl. G06T 19/20

(52) U.S. Cl. CPC G06T 19/20; G06T 2207/10028; G06T 7/50; G06T 2200/24; G06T 2219/2016

(57) ABSTRACT

A three dimensional display of point cloud data on a screen is rotated at improved working efficiency. An image processing device includes a point cloud data display controlling unit and a marker display controlling unit. The point cloud data display controlling unit controls rotation of a three dimensional display of point cloud data on a screen. The marker display controlling unit controls display of a rotational marker that indicates the direction of the rotation. The rotational marker is displayed on the screen at a position specified by an operator. The three dimensional display of the point cloud data is rotatable around the position of the rotational marker.

### BACKGROUND OF THE INVENTION

### Technical Field

The present invention relates to an image processing technique for point cloud data.

### Background Art

Point cloud data that are obtained by using a laser scanner or by stereophotogrammetry are publicly known (for example, refer to WO 2011/070927 and Japanese Unexamined Patent Application Laid-Open No. 2012-230594).

Point cloud data of an object to be measured can generate a three-dimensional shape of the object when three-dimensionally displayed on a screen of a PC or of other device. The point cloud data is typically used for obtaining a three-dimensional model therefrom. The three-dimensional model is data showing an outline of an object to be measured and has a high affinity to three-dimensional data that can be processed by CAD software.

Point cloud data does not contain data at hidden portions as seen from a point of view. This phenomenon is called “occlusion”. To generate a three-dimensional model containing no occluded portions, point clouds are obtained from multiple points of view and are synthesized. In this case, the point clouds that are obtained from different points of view must be matched with each other. The matching is performed by using a publicly known matching technique, such as template matching, after positions of two point clouds are approximately made to correspond with each other.

### SUMMARY OF THE INVENTION

The positions of two point clouds are approximately made to correspond manually by an operator. At this time, the point clouds are moved in parallel and are rotated. This processing step greatly affects working efficiency. An object of the present invention is to provide a technique for improving working efficiency in rotating a three dimensional display of point cloud data on a screen.

A first aspect of the present invention provides an image processing device including a point cloud data display controlling unit and a marker display controlling unit. The point cloud data display controlling unit controls rotation of a three dimensional display of point cloud data on a screen. The marker display controlling unit controls display of a rotational marker that indicates the direction of the rotation. The rotational marker is displayed on the screen at a position specified by an operator. The three dimensional display of the point cloud data is rotatable around the position of the rotational marker.

According to a second aspect of the present invention, in the invention according to the first aspect of the present invention, the image processing device may further include a plane direction calculator that calculates a direction of a plane of the point cloud data at the position of the rotational marker. The marker display controlling unit may control the direction of the rotational marker in accordance with the direction of the plane.

According to a third aspect of the present invention, in the invention according to the second aspect of the present invention, the direction of the plane may be calculated by extracting multiple point clouds, including a point cloud at the position specified by the operator, and calculating a plane that fits to the extracted multiple point clouds.

According to a fourth aspect of the present invention, in the invention according to the second or the third aspect of the present invention, the rotational marker may be constituted of three circles that have a common center and that have center axes of which directions orthogonally cross each other. The marker display controlling unit may control the direction of the center axis of one of the three circles to be aligned with the direction of the plane.

A fifth aspect of the present invention provides an image processing method including controlling rotation of a three dimensional display of point cloud data on a screen and controlling display of a rotational marker that indicates the direction of the rotation. The rotational marker is displayed on the screen at a position specified by an operator. The three dimensional display of the point cloud data is rotatable around the position of the rotational marker.

A sixth aspect of the present invention provides a non-transitory computer recording medium storing computer executable instructions that, when executed by a computer processor, cause the computer processor to control rotation of three dimensional display of point cloud data on a screen and to control display of a rotational marker that indicates the direction of the rotation. The rotational marker is displayed on the screen at a position specified by an operator. The three dimensional display of the point cloud data is rotatable around the position of the rotational marker.

The present invention improves working efficiency in rotating a three dimensional display of point cloud data on a screen.

### BRIEF DESCRIPTION OF DRAWINGS

FIG. 1 is a block diagram of an embodiment.

FIG. 2 shows an example of a displayed screen.

FIG. 3 shows an example of a displayed screen.

FIG. 4 shows an example of a displayed screen.

FIG. 5 shows an example of a displayed screen.

FIG. 6 shows an example of a rotational marker.

### PREFERRED EMBODIMENTS OF THE INVENTION

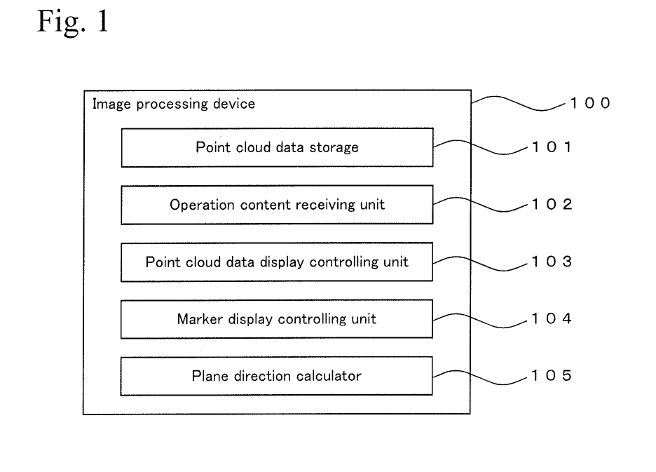

FIG. 1 shows an image processing device 100 that is configured to process point cloud data. Typically, the image processing device 100 is constructed not by dedicated hardware but by application software using a personal computer (PC). The application software may be installed in the PC and is operated to execute the function of the image processing device 100.

When a PC is used, each functional unit shown in FIG. 1 is constructed by software. Each of the functional units shown in FIG. 1 may be composed of a dedicated arithmetic circuit. A functioning unit constructed of software and a functioning unit composed of a dedicated arithmetic circuit may be used together. For example, each of the functional units shown in the drawing may be constructed of an electronic circuit such as a central processing unit (CPU), an application specific integrated circuit (ASIC), or a programmable logic device (PLD) such as a field programmable gate array (FPGA).

Whether each of the functional units is to be constructed of dedicated hardware or is to be constructed of software so that programs are executed by a CPU is selected in consideration of necessary operating speed, cost, amount of electricity consumed, and other factors. For example, if a specific functional unit is composed of an FPGA, the operating speed is superior, but the production cost is high. On the other hand, if a specific functional unit is configured so that programs are executed by a CPU, the production cost is reduced because hardware resources are conserved. However, when the functional unit is constructed using a CPU, its operating speed is inferior to that of dedicated hardware. Constructing the functional unit by dedicated hardware and constructing the functional unit by software differ from each other, as described above, but are equivalent to each other from the viewpoint of obtaining a specific function.

The image processing device 100 includes a point cloud data storage 101, an operation content receiving unit 102, a point cloud data display controlling unit 103, a marker display controlling unit 104, and a plane direction calculator 105. The point cloud data storage 101 stores point cloud data that is measured by a three dimensional laser scanner. The point cloud data may also be obtained by a method of calculating three-dimensional coordinates of numerous feature points that are extracted from photographed images, based on the principle of stereophotogrammetry.

The operation content receiving unit 102 receives data relating to an operation content of an operator using the image processing device 100. For example, an operator may perform various kinds of work by operating a PC that is operated as the image processing device 100, and an operation content of the operator using the PC is received by the operation content receiving unit 102. The operation content receiving unit 102 also receives a content of an operation using a translational marker or a rotational marker. The translational marker and the rotational marker are displayed under control of the marker display controlling unit 104, which is described later.

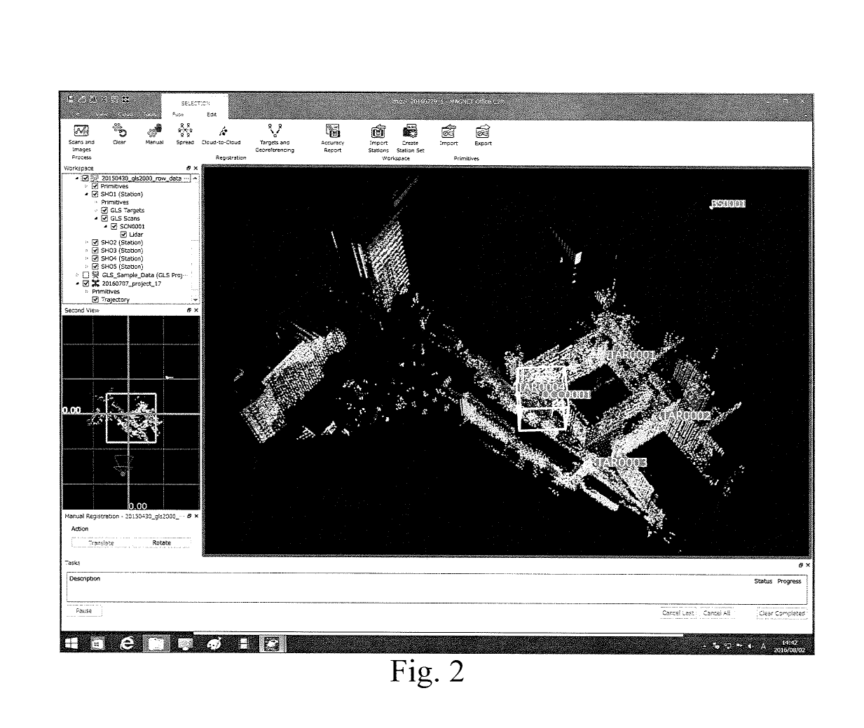

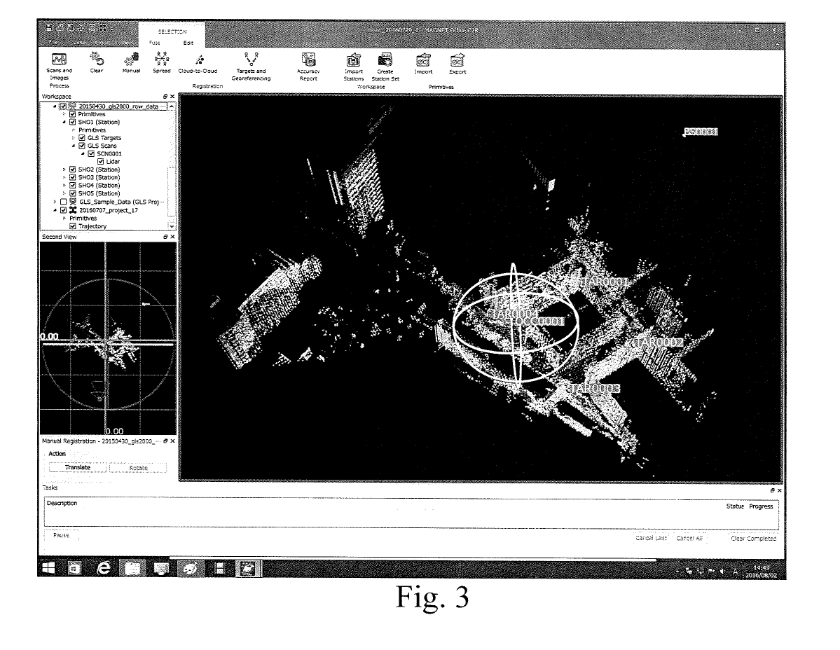

FIG. 2 shows the translational marker, and FIG. 3 shows the rotational marker. The translational marker is an example of a mark indicating directions of three axes. The translational marker is a cube-shaped line figure that is movable in parallel and is rotatable in conjunction with a three dimensional display of the point cloud data. Specifically, when one of viewable planes of the marker is specified by clicking the left button of a mouse and is dragged, the entirety of the point clouds that are displayed in a direction parallel to the specified plane are moved. Specifying a plane defined by the translational marker enables selection of the parallel moving direction from the directions of the three axes. The three axes of the translational marker are preferably respectively corresponded to a vertical direction, the north-south direction, and the east-west direction. This enables easy understanding of the directions of a building or other target object that is represented by the three-dimensional display of the point cloud data.

The rotational marker is an example of a mark indicating rotation positions of three axes. The rotational marker is movable in parallel and is rotatable in conjunction with a three dimensional display of the point cloud data. The rotational marker is constituted of three circles that have a common center and that have center axes of which the directions orthogonally cross each other. Specifically, when one of the three circles (rings) constituting the rotational marker is specified by clicking the left button of a mouse and is dragged, the specified circle rotates around an axis in a direction vertical to its center axis (symmetric axis passing through its center). This rotation makes the three dimensional display of the point clouds rotate at the same time. The rotation axes of the three circles orthogonally cross each other, and therefore, one of the rotations around the three axes is selected by specifying the circle.

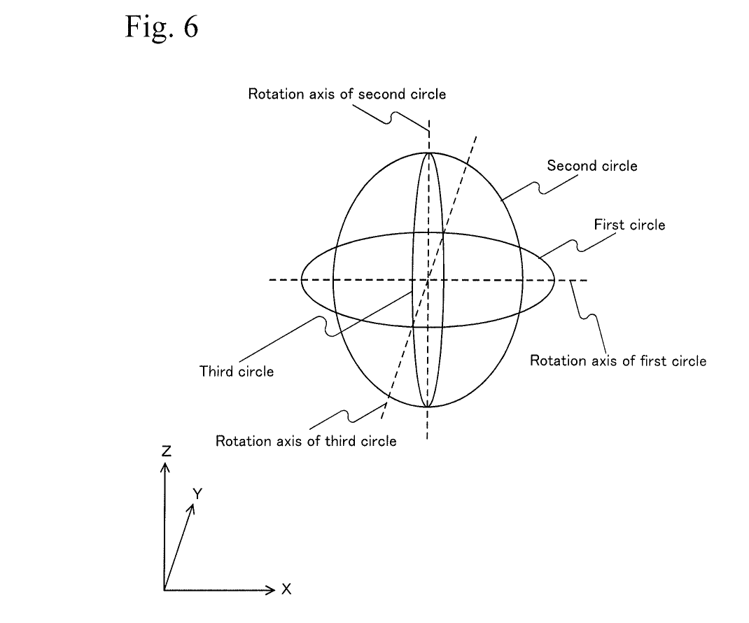

FIG. 6 shows an example of the rotational marker. In the case shown in FIG. 6, when the first circle is rotated, the three dimensional display of the point cloud data rotates around the X axis. Also, when the second circle is rotated, the three dimensional display of the point cloud data rotates around the Z axis. Also, when the third circle is rotated, the three dimensional display of the point cloud data rotates around the Y axis. The rotation axis of the second circle shown in FIG. 6 is the center axis of the first circle. For example, the extending directions of the three rotation axes of the rotational marker may be respectively made to correspond to the vertical direction, the north-south direction, and the east-west direction. This enables easy understanding of the rotation directions of the three dimensional display of the point cloud data.

FIG. 2 shows a situation in which indication of the translational marker is selected. FIG. 3 is a situation in which indication of the rotational marker is selected. To move the three dimensional display of the point cloud data in parallel, indication is selected as shown in FIG. 2, and the translational marker is operated. To rotate the three dimensional display of the point cloud data, indication is selected as shown in FIG. 3, and the rotational marker is operated.

The point cloud data display controlling unit 103 controls three dimensional display of the point cloud data on a PC or an appropriate display, such as a liquid crystal display. An example of point cloud data that is displayed on a screen is shown in each of FIGS. 2 and 3. The point cloud data display controlling unit 103 controls display of parallel movement and rotation of the three dimensional display of the point cloud data, which are performed by using the translational marker and the rotational marker. Although not shown in FIGS. 2 and 3, the azimuths (north, south, east, and west) of the point cloud data may also be displayed.

The marker display controlling unit 104 controls display of the translational marker and the rotational marker, as well as performs accompanying various controls. The translational marker and the rotational marker can be moved to any position on a screen by an operator. In particular, the rotational marker has characteristic functions as described below.

As described above, the rotational marker can be moved to any position on a screen by an operator. The three dimensional display of the point cloud data on the screen is rotated around a position (at the intersection of the three rotation axes) of the rotational marker on the screen. The position is specified by the operator.

The direction of the rotational marker, that is, the center axes of the three circles of the rotational marker can be set in accordance with one of the following settings. In a first setting, the rotation axis of the first circle is directed in a vertical direction, the rotation axis of the second circle is directed in the east-west direction, and the rotation axis of the third circle is directed in the north-south direction. In a second setting, the extending direction of the rotation axis of the first circle is corresponded to the direction of a plane composed of point cloud data at a position (at the center) of the rotational marker. The position is specified by the operator.

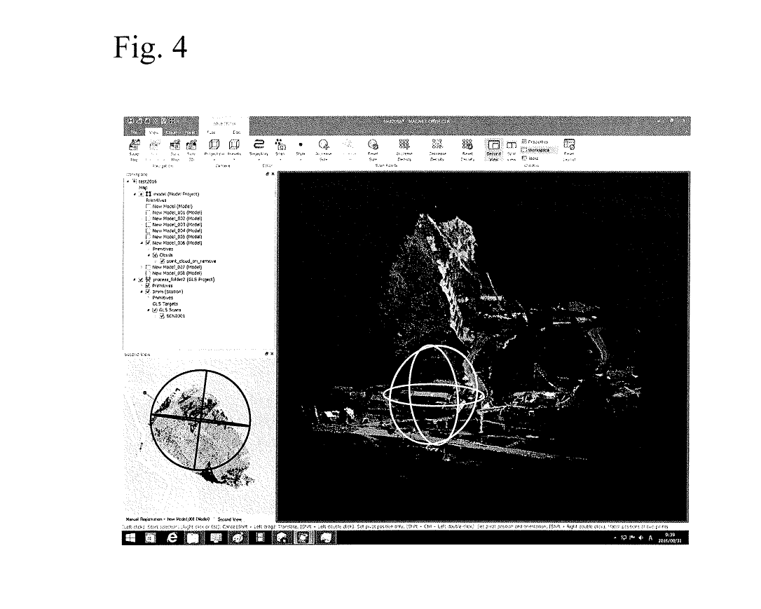

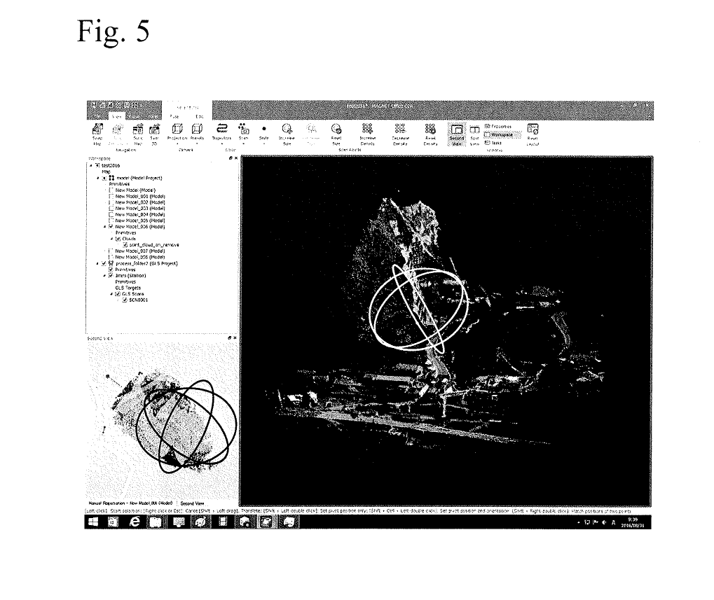

The case of the second setting is shown in FIGS. 4 and 5. Although FIGS. 4 and 5 show gray scale images, these images can be easily understandable three dimensional displays of point cloud data, of which each point is colored based on photographed images that are photographed when the point cloud data is obtained, in actual use. FIGS. 4 and 5 show three dimensional displays of point cloud data in a construction site in a mountainous area.

In the case shown in FIG. 4, a flat area is specified as the center of the rotational marker. In this case, since the flat area is specified, the center axis of one of the circles constituting the rotational marker is directed in approximately a vertical direction. The directions of the center axes of the other two circles may not necessarily be determined, but may be set by an operator as desired.

In the case shown in FIG. 5, a slope (cliff) area is specified as the center of the rotational marker. In this case, the displayed rotational marker has its circle of which the center axis is directed in a normal direction of the slope.

A three dimensional display of point cloud data is rotated by typically focusing on a plane of a target object. The display of the rotational marker in the condition as exemplified in FIG. 4 or 5 enables visually understandable rotation control of the three dimensional display of the point cloud data.

The plane direction calculator 105 calculates the direction of a plane composed of points at the position (at the rotation center) of the rotational marker. This processing is performed as follows. First, a point at or nearest to the center of the rotational marker received by the operation content receiving unit 102 is obtained as a target point. Then, data of points of a square region having sides with odd numbers, such as 9×9, with the target point at the center, is obtained. The size of the square region may be specified by an operator.

Next, an equation of a plane that fits to the square region is obtained. Here, an equation of a plane that fits to the square region is derived by using a least-squares method. Specifically, multiple different plane equations are obtained and compared with each other, and then the equation of a plane that fits to the square region is derived. Then, the direction of a normal line of a calculated plane is obtained as the direction of the plane. Thus, the direction of the plane composed of the points at the position (at the rotation center) of the rotational marker is calculated.

The translational marker and the rotational marker enable easy parallel movement and rotation of a three dimensional display of point cloud data on a screen, as well as enable an operator to easily understand the displayed image. In some cases, the translational marker and the rotational marker may be displayed in the same image.

What is claimed is:

1. An image processing device comprising:
a point cloud data display controlling unit that controls rotation of a three dimensional display of point cloud data on a screen; and
a marker display controlling unit that controls display of a rotational marker, which indicates the direction of the rotation,
wherein the rotational marker is displayed on the screen at a position specified by an operator, and the three dimensional display of the point cloud data is rotatable around the position of the rotational marker.

2. The image processing device according to claim 1, further comprising:
a plane direction calculator that calculates a direction of a plane of the point cloud data at the position of the rotational marker,
wherein the marker display controlling unit controls the direction of the rotational marker in accordance with the direction of the plane.

3. The image processing device according to claim 2, wherein the direction of the plane is calculated by extracting multiple point clouds, including a point cloud at the position specified by the operator, and calculating a plane that fits to the extracted multiple point clouds.

4. The image processing device according to claim 2, wherein the rotational marker is constituted of three circles that have a common center and that have center axes of which directions orthogonally cross each other, and the marker display controlling unit controls the direction of the center axis of one of the three circles to be aligned with the direction of the plane.

5. An image processing method comprising:
controlling rotation of a three dimensional display of point cloud data on a screen; and
controlling display of a rotational marker that indicates the direction of the rotation,
wherein the rotational marker is displayed on the screen at a position specified by an operator, and the three dimensional display of the point cloud data is rotatable around the position of the rotational marker.

6. A non-transitory computer recording medium storing computer executable instructions that, when executed by a computer processor, cause the computer processor to:
control rotation of three dimensional display of point cloud data on a screen; and
control display of a rotational marker that indicates the direction of the rotation,
wherein the rotational marker is displayed on the screen at a position specified by an operator, and the three dimensional display of the point cloud data is rotatable around the position of the rotational marker.

7. The image processing device according to claim 3, wherein the rotational marker is constituted of three circles that have a common center and that have center axes of which directions orthogonally cross each other, and the marker display controlling unit controls the direction of the center axis of one of the three circles to be aligned with the direction of the plane.
